(19) United States
(12) Patent Application Publication
(10) Pub. No.: US 2008/0004919 A1
(43) Pub. Date: Jan. 3, 2008

(54) Triggered transactions based on criteria

(75) Inventor: William Anthony Stubbs, Oakland, CA (US)

Correspondence Address: GREENBERG TRAURIG, LLP (SV);IP DOCKETING, 2450 COLORADO AVENUE, SUITE 400E, SANTA MONICA, CA, 90404, US

(73) Assignee: Rearden Commerce, Inc.

(21) Appl. No.: 11/479,598

(22) Filed: Jun. 30, 2006

(51) Int. Cl. G06Q 10/00

(52) U.S. Cl. 705/5

(57) ABSTRACT

One embodiment includes a method for triggered transactions based on criteria. In one embodiment, the method can be implemented on a system. In one embodiment, based on a person's travel destination, the method includes proposing venues and establishments for the upcoming trip that have been visited in previous trips to the same place. In addition, even if the destination is part of a trip with multiple destinations, the proposals for each previously visited destination are made based on those previous individual visits.

### BACKGROUND OF THE INVENTION

People often travel repeatedly to the same destinations. And when they visit the same places over and over again, they develop preferences for the same establishments, such as restaurants and hotels, whenever they go, because a) they don't have to take the time and trouble to research new establishments, and b) they feel comfortable and “at home” in these familiar surroundings.

What is clearly needed is a system and method that, based on a person's travel destination, proposes venues and establishments for the upcoming trip that have been visited in previous trips to the same place. In addition, even if the destination is part of a trip with multiple destinations, the proposals for each previously visited destination are made based on those previous individual visits. What is further needed is a system and method for selecting other “preferred” venues and establishments, based on criteria such as who is to be met at each destination or who is paying for the visit and optionally automatically booking such preferred items when the primary booking occurs.

### SUMMARY OF THE INVENTION

One embodiment includes a method for triggered transactions based on criteria. In one embodiment, the method can be implemented on a system. In one embodiment, based on a person's travel destination, the method includes proposing venues and establishments for the upcoming trip that have been visited in previous trips to the same place. In addition, even if the destination is part of a trip with multiple destinations, the proposals for each previously visited destination are made based on those previous individual visits.

### BRIEF DESCRIPTION OF THE DRAWINGS

FIG. 1 shows an exemplary system according to one embodiment, containing an electronic services portal and Internet;

FIG. 2 shows an overview of an exemplary storage organization with a trip archive of a customer.

FIG. 3 shows an overview of an exemplary system containing an interaction screen;

FIG. 4 shows an overview of a histogram; and

FIG. 5 shows a process 500 for proposing venues and establishments for a trip according to one embodiment.

### DETAILED DESCRIPTION OF THE INVENTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional, and other changes may be made without departing from the scope of the present invention. The following detailed description is, therefore, not to be taken in a limiting sense, and the scope of the present invention is defined only by the appended claims.

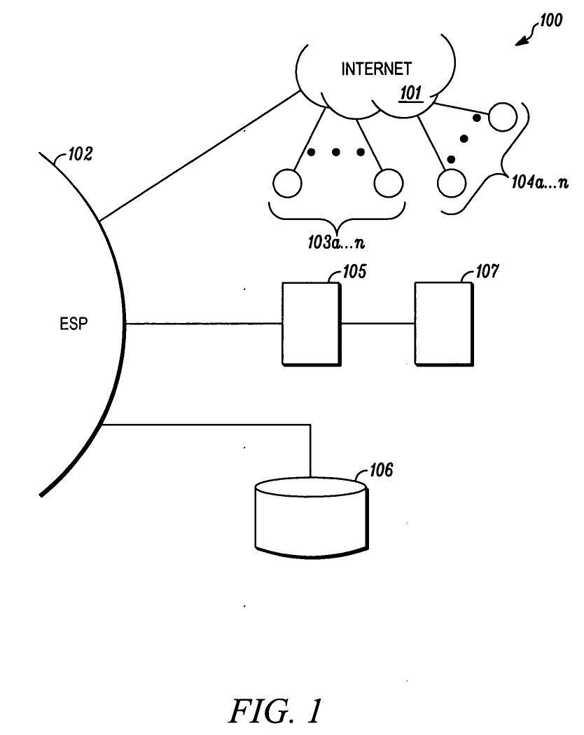

FIG. 1 shows an exemplary system 100 according to one embodiment, containing an electronic services portal 102 and Internet 101. Services portal 102 has at least one server 105 with a software instance 107, containing both software for the novel implementation and possibly other software, and also a storage unit 106. Portal 102 is typically connected to Internet 101, as are customers 103 a-n and vendors and suppliers 104 a-n.

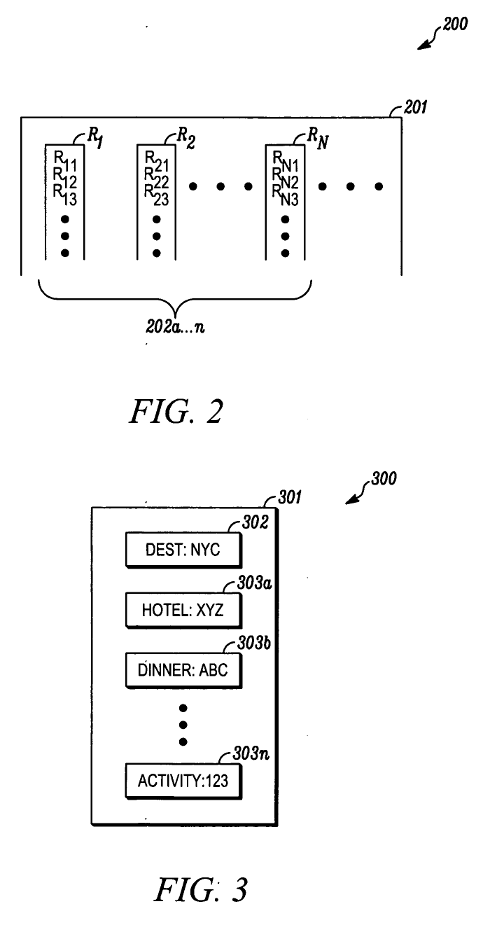

FIG. 2 shows an overview of an exemplary storage organization 200 with a trip archive 201 of a customer. Shown are reservation sets R1 through Rn 202 a-n. Each reservation set contains multiple single reservations R11, R2, R13 and so forth in R1; R21, R22, R23 and so forth in R2; and Rn1 Rn2, Rn3 and so on in Rn. It is clear that there may be many more reservations in such an archive, and it is also clear that the reservations may have multiple destinations (or only one item), within which a subset of reservations is made for each destination, but, for purposes of clarity and simplicity, these details are not shown.

FIG. 3 shows an overview of an exemplary system 300 containing an interaction screen 301. Shown is a destination field 302 with destination New York City entered by a user (not shown). In other fields 303a, 303b, through 303n, the system prompts the user by displaying default preferred values for each field. The defaults may be calculated solely oh previous selections for that parameter, or the calculations of the default value may take into account such criteria as budget, choices allowed by the entity paying for the trip, payment method, seasonality, day of week, month of year, type of travel, duration of travel, person(s) being met on travel, distance between segment destinations (e.g. hotel-airport distance), preferred dining preferences, sporting preferences, entertainment preferences etc.

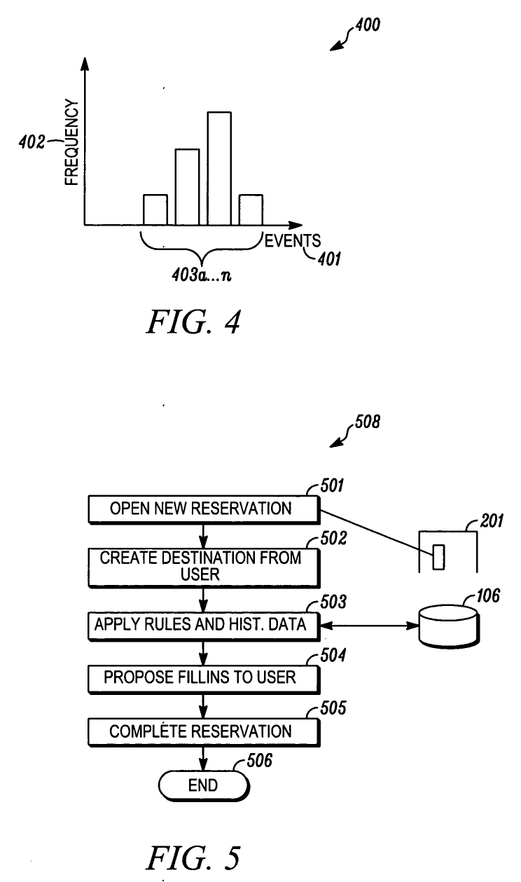

FIG. 4 shows an overview of a histogram 400. Frequency 402 of a type of events 401 is shown as bars 403 a-n. Typically, for each event type, the bar with the highest frequency would be displayed as a default value in a field in screen 301, described above. However, the user may, at his choice, for example by pull-down menu, be offered the other options of the histograms (of each respective field 303a . . . n), or he may enter any other unrelated or unknown item, which the system would treat as a new entry.

For example, whenever a user flies to New York, the system would automatically propose a reservation for dinner at restaurant X, or automatically proposed to book a limo to pick him up, etc. Such a system could save people the time of having to go through the booking flow for each individual service. In addition, the system could also automatically cancel such bookings and reservation, so that, for example, if a user cancels his travel reservations, the system would automatically cascade that cancellation to include all other trip reservations.

FIG. 5 shows a process 500 for proposing venues and establishments for a trip according to one embodiment. In process 501, a user opens an on-screen form to enter a new travel reservation. A new reservation set (or record) is created in trip archive 201. In process 502, the system prompts the user for his destination, and in process 503, the system applies rules and historical data drawn from data storage unit 106, so that in process 502, the remaining fields of venues and establishments are populated with calculated proposals. It is clear that historical frequency of use is only one example of criteria that may be used to propose bookings. Besides, the user may create or enter a set of preferences for each destination, by itself or with dependencies. In fact, the preferred venue may not be the most frequent one, but one that is rarely available. The user may accept the system's proposals or replace them with other selections (not shown), thus completing the reservations in process 505. In process 506, the process ends.

At least some embodiments, and the different structure and functional elements described herein, can be implemented using hardware, firmware, programs of instruction, or combinations of hardware, firmware, and programs of instructions.

In general, routines executed to implement the embodiments can be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations to execute elements involving the various aspects.

While some embodiments have been described in the context of fully functioning computers and computer systems, those skilled in the art will appreciate that various embodiments are capable of being distributed as a program product in a variety of forms and are capable of being applied regardless of the particular type of machine or computer-readable media used to actually effect the distribution.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks, (DVDs), etc.), among others. The instructions can be embodied in digital and analog communication links for electrical, optical, acoustical or other forms of propagated signals, such as carrier waves, infrared signals, digital signals, etc.

A machine readable medium can be used to store software and data which when executed by a data processing system causes the system to perform various methods. The executable software and data can be stored in various places including for example ROM, volatile RAM, non-volatile memory and/or cache. Portions of this software and/or data can be stored in any one of these storage devices.

In general, a machine readable medium includes any mechanism that provides (i.e., stores and/or transmits) information in a form accessible by a machine (e.g., a computer, network device, personal digital assistant, manufacturing tool, any device with a set of one or more processors, etc.).

Some aspects can be embodied, at least in part, in software. That is, the techniques can be carried out in a computer system or other data processing system in response to its processor, such as a microprocessor, executing sequences of instructions contained in a memory, such as ROM, volatile RAM, non-volatile memory, cache, magnetic and optical disks, or a remote storage device. Further, the instructions can be downloaded into a computing device over a data network in a form of compiled and linked version.

Alternatively, the logic to perform the processes as discussed above could be implemented in additional computer and/or machine readable media, such as discrete hardware components as large-scale integrated circuits (LSI's), application-specific integrated circuits (ASIC's), or firmware such as electrically erasable programmable read-only memory (EEPROM's).

In various embodiments, hardwired circuitry can be used in combination with software instructions to implement the embodiments. Thus, the techniques are not limited to any specific combination of hardware circuitry and software nor to any particular source for the instructions executed by the data processing system.

In this description, various functions and operations are described as being performed by or caused by software code to simplify description. However, those skilled in the art will recognize what is meant by such expressions is that the functions result from execution of the code by a processor, such as a microprocessor.

Although some of the drawings illustrate a number of operations in a particular order, operations which are not order dependent can be reordered and other operations can be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

In the foregoing specification, the disclosure has been described with reference to specific exemplary embodiments thereof. It will be evident that various modifications can be made thereto without departing from the broader spirit and scope of the invention as set forth in the following claims. The specification and drawings are, accordingly, to be regarded in an illustrative sense rather than a restrictive sense.

What is claimed is:

1) A method comprising:
Receiving via an on-line form, a request from a user for a travel reservation;
Prompting the user for a destination of the travel reservation;
Populating additional fields of the on-line form with proposed reservations, based on historical data.

2) The method of claim 1, wherein the historical data includes historical data from prior travel of the user.

3) The method of claim 1, wherein the historical data is based on a historical frequency of the user.

4) The method of claim 1, wherein the additional fields of the on-line form include at least one of venues and establishments.

5) The method of claim 1, wherein the populating further includes populating the additional fields of the on-line form with proposed reservations, based on preferences previously identified by the user.

6) The method of claim 1, wherein the populating further includes populating the additional fields of the on-line form with proposed reservations, based on a person identified as paying for the travel.

7) The method of claim 1, wherein the populating further includes populating the additional fields of the on-line form with proposed reservations, based on one or more of pre-identified budget, pre-identified choices allowed by an entity or person paying for the travel, a payment method, a time period of the travel, an identified method of transportation, duration of travel, an identified person to be visited on the travel, distance between segment destinations, preferred dining preferences, sporting preferences, or entertainment preferences.

8) A machine readable medium having stored thereon a set of instructions, which when executed perform a method comprising:
Receiving via an on-line form, a request from a user for a travel reservation;
Prompting the user for a destination of the travel reservation;
Populating additional fields of the oh-line form with proposed reservations, based on historical data.

9) The machine readable medium of claim 8, wherein the historical data includes historical data from prior travel of the user.

10) The machine readable medium of claim 8, wherein the historical data is based on a historical frequency of the user.

11) The machine readable medium of claim 8, wherein the additional fields of the on-line form include at least one of venues and establishments.

12) The machine readable medium of claim 8, wherein the populating further includes populating the additional fields of the on-line form with proposed reservations, based on preferences previously identified by the user.

13) The machine readable medium of claim 8, wherein the populating further includes populating the additional fields of the on-line form with proposed reservations, based on a person identified as paying for the travel.

14) The machine readable medium of claim 8, wherein the populating further includes populating the additional fields of the on-line form with proposed reservations, based on one or more of pre-identified budget, pre-identified choices allowed by an entity or person paying for the travel, a payment method, a time period of the travel, an identified method of transportation, duration of travel, an identified person to be visited on the travel, distance between segment destinations, preferred dining preferences, sporting preferences, or entertainment preferences.

15) A system comprising:
Receiving via an on-line form, a request from a user for a travel reservation;
Prompting the user for a destination of the travel reservation;
Populating additional fields of the on-line form with proposed reservations, based on historical data.

16) The system of claim 15, wherein the historical data includes historical data from prior travel of the user.

17) The system of claim 15, wherein the historical data is based on a historical frequency of the user.

18) The system of claim 15, wherein the additional fields of the on-line form include at least one of venues and establishments.

19) The system of claim 15, wherein the populating further includes populating the additional fields of the on-line form with proposed reservations, based on preferences previously identified by the user.

20) The system of claim 15, wherein the populating further includes populating the additional fields of the on-line form with proposed reservations, based on one or more of pre-identified budget, pre-identified choices allowed by an entity or person paying for the travel, a payment method, a time period of the travel, an identified method of transportation, duration of travel, an identified person to be visited on the travel, distance between segment destinations, preferred dining preferences, sporting preferences, or entertainment preferences.
